(19) United States
(12) Patent Application Publication
(10) Pub. No.: US 2013/0106352 A1
(43) Pub. Date: May 2, 2013

(54) BATTERY CHARGER, BATTERY PACK DOCKING MODULE, AND BATTERY PACK MODULE

(71) Applicant: Hiroshi NAGAMINE, Sumoto-shi (JP)

(72) Inventor: Hiroshi NAGAMINE, Sumoto-shi (JP)

(21) Appl. No.: 13/440,144

(22) Filed: Apr. 5, 2012

(30) Foreign Application Priority Data
Oct. 31, 2011 (JP) 2011-239785

(51) Int. Cl. H02J 7/00

(52) U.S. Cl. 320/113

(57) ABSTRACT

The battery charger is capable of charging a battery pack 2. The battery charger is provided with a docking section 1 where the battery pack 2 can be attached for charging, and a charging section 3 with a charging circuit 40 to supply a given amount of charging power to the battery pack 2 attached in the docking section 1. The battery charger is characterized by the docking section 1 and charging section 3 having a detachable structure.

### BACKGROUND OF THE INVENTION

1. Field of the Invention

The present invention relates to a battery charger that can charge an attached battery pack, to a battery pack docking module, and to a battery pack module.

2. Description of the Related Art

Battery chargers have been developed to charge battery packs. These battery chargers charge a battery pack by attaching the battery pack and connecting an alternating current (AC) adapter. Meanwhile, battery-powered devices such as digital cameras, video cameras, solid-state audio recorders, and MP3 players generally have a special-purpose battery pack designed for each device type. Consequently, the state-of-the-art has evolved using specially designed battery chargers that meet individual battery pack specifications such as battery pack size, electrode-terminal position, and charging current and voltage. However, from the perspective of the battery pack supplier, a special-purpose battery charger must be designed for each battery pack, and design cost is an issue. In particular, each time a new device type is developed, a battery charger for that device type must be made available, and supply for old device types must be supported for a given time period. Accordingly, the supplier is burdened with manufacture and administration of many different types of products made in small quantities. Further, from the perspective of the user, a special-purpose battery charger must be obtained for each battery-powered device, and the sheer volume of battery chargers makes it difficult to determine which battery charger charges which battery pack.

Refer to Japanese Laid-Open Patent Publication 2007-166825

The present invention was developed considering the prior-art problems described above. Thus, it is a primary object of the present invention to provide a battery charger, battery pack docking module, and battery pack module that can avoid furnishing a specially designed battery charger for each different battery pack.

### SUMMARY OF THE INVENTION

To achieve the object described above, the battery charger for the first aspect of the present invention is capable of charging a battery pack 2, is provided with a docking section 1 where the battery pack 2 can be attached for charging, and is provided with a charging section 3 having a charging circuit 40 to supply a given amount of charging power to the battery pack 2 attached in the docking section 1. The battery charger is characterized by the docking section 1 and charging section 3 having a detachable structure. Accordingly, a docking section is made for each battery pack corresponding to the battery pack shape and electrode configuration etc. Using a common charging section while exchanging docking sections avoids the requirement to provide a specially designed battery charger to charge each different battery pack.

In the battery charger for the second aspect of the present invention, the charging section 3 can have a connector 9 to receive external charging power to charge the battery pack 2, and that connector 9 can be a standardized connector that meets certain specifications. By supplying power through a standardized connector, provision of an external power supply such as an AC adapter becomes unnecessary, and this achieves the positive feature that the battery charger can be made compact.

In the battery charger for the third aspect of the present invention, the connector 9 can be a universal serial bus (USB) connector 9A. Accordingly, power can be supplied from a widely available USB port used as the power source. This makes the use of an external power supply such as an AC adapter unnecessary and achieves the positive feature that the battery charger can be made compact.

In the battery charger for the fourth aspect of the present invention, the USB connector 9A can extend out from the charging section 3 through a flexible cable 49, and the docking section 1 can be provided with a connector storing cavity 29 to hold the USB connector 9A. As a result, the USB connector is not mounted directly on the charging section, and extension via the cable improves handling and connect-ability. Further, when the charging section and docking section are connected, the connector can be stored to keep the cable out of the way.

In the battery charger for the fifth aspect of the present invention, the charging section 3 has a box-shaped exterior and one rectangular surface of the box-shaped charging section 3 can be a charging section-side attachment surface 30A for attachment with the docking section 1. The docking section 1 can have a docking section-side attachment surface 10A for attachment with the charging section 3 that has a long side, which is shorter than the length of the charging section-side attachment surface 30A, and a short side, which is approximately equal to the short side of the charging section-side attachment surface 30A. The end-plane at the opposite end of the docking section 1 from the docking section-side attachment surface 10A can be approximately the same size as the charging section-side attachment surface 30A. When the charging section 3 and the docking section 1 are connected, a recessed region 50 is formed along a side 1S of the battery charger, and the USB connector 9A can be disposed in that recessed region 50. By disposing the USB connector in the recessed region of the connected charging section and docking section, the flexible USB cable is prevented from jutting out from the surface of the battery charger allowing a neat assembly.

In the battery charger for the sixth aspect of the present invention, the charging section 3 can be provided with a charging section-side connector 5 for electrical connection with the docking section 1, and the docking section 1 can be provided with a docking section-side connector 7 for electrical connection with the charging section 3. The docking section-side connector 7 can be a female connector, the charging section-side connector 5 can be a male connector, and the docking section-side connector 7 and charging section-side connector 5 can be configured to fit together. A configuration with a female docking section-side connector on the docking section, where a battery pack can be attached, makes it difficult for the user to inadvertently touch the contacts, and this can improve safety.

In the battery charger for the seventh aspect of the present invention, the docking section 1 can be provided with a battery loading cavity 20 to attach a battery pack 2 in a given orientation. The battery loading cavity 20 can be provided with perimeter side-walls that surround a battery pack 2 attached in the battery loading cavity 20. The perimeter side-walls can include a first side-wall 22 that faces the terminal-end 2X of the battery pack 2 where output terminals 2S are established, and a second side-wall 24 at the opposite end of the battery loading cavity 20 from the first side-wall 22 that faces the bottom 2Y of the battery pack 2, which is at the opposite end of the battery pack 2 from the terminal-end 2X. The first side-wall 22 can be provided with an overhang 26 that protrudes out to cover the terminal-end 2X of a battery pack 2 attached in the battery loading cavity 20, and the second side-wall 24 can be provided with a battery pack removal slot 25 that exposes the bottom 2Y end of a battery pack 2 attached in the battery loading cavity 20. This achieves the positive features that battery pack output terminals and associated connecting terminals in the battery loading cavity can be protected from operator handling and dust or dirt ingress, and exposure of the bottom of the battery pack at the opposite end of the battery loading cavity allows the user to easily load and unload the battery pack.

The battery pack docking module for the eighth aspect of the present invention can connect with a charging section 3 capable of charging a battery pack 2 to form a battery charger, and is provided with a battery loading cavity 20 where a battery pack 2 can be loaded for charging, and a docking section-side connector 7 that connects in a detachable manner with the charging section 3 for electrical connection. The battery pack docking module is configured to attach a battery pack 2 in the battery loading cavity 20 with the charging section 3 connected via the docking section-side connector 7, and charge the battery pack 2 by receiving a prescribed amount of charging power supplied from the charging section 3. Accordingly, by exchanging the battery pack docking module to one conforming to the shape and electrode configuration etc. of the battery pack to be charged, and using a common charging section, the battery pack can be attached and charged. Further, each different battery pack does not require a special-purpose battery charger, and many different types of battery packs can be charged by exchanging only the battery pack docking module.

The battery pack module for the ninth aspect of the present invention is provided with a battery pack 2 that can be charged, and a docking section 1 that connects in a detachable manner with a charging section 3, which supplies a prescribed amount of charging power to the battery pack 2. The battery pack 2 is attached in the docking section 1, and the docking section 1 is connected with the charging section 3 to charge the battery pack 2. Accordingly, a battery pack and docking section conforming to the shape and electrode configuration etc. of that battery pack can be treated as an exchangeable modular unit that can be conveniently used with a common charging section to allow different types of battery packs to be charged. Further, each different battery pack does not require a special-purpose battery charger allowing many different types of battery packs to be charged. The above and further objects of the present invention as well as the features thereof will become more apparent from the following detailed description to be made in conjunction with the accompanying drawings.

### BRIEF DESCRIPTION OF THE DRAWINGS

FIG. 1 is an oblique view of a battery charger for the first embodiment;

FIG. 2 is an oblique view showing the battery charger of FIG. 1 in use;

FIG. 3 is an exploded oblique view showing the detachable structure of the charging section and docking section of the battery charger in FIG. 1;

FIG. 4 is an oblique view from behind and below the battery charger in FIG. 3;

FIG. 5 is an exploded cross-section view of the battery charger in FIG. 1;

FIG. 6 is a cross-section view showing the connecting structure of the battery charger in FIG. 1;

FIG. 7 is an exploded oblique view showing the internal structure of the battery charger in FIG. 1;

FIG. 8 is an oblique view showing attachment of a battery pack in the battery charger of FIG. 1;

FIG. 9 is an oblique view showing attachment of a different battery pack in the battery charger of FIG. 1; and

FIG. 10 is a block diagram of the battery charger in FIG. 1.

### DETAILED DESCRIPTION OF THE EMBODIMENT(S)

The following describes embodiments of the present invention based on the figures. However, the following embodiments are merely specific examples of a battery charger and battery pack module representative of the technology associated with the present invention, and the battery charger and battery pack module of the present invention is not limited to the embodiments described below. Further, components cited in the claims are in no way limited to the components in the embodiments. In particular, in the absence of specific annotation, structural component features described in the embodiments such as dimensions, raw material, shape, and relative position are simply for the purpose of explicative example and are in no way intended to limit the scope of the invention. Properties such as the size and spatial relation of components shown in the figures may be exaggerated for the purpose of clear explanation. In the descriptions following, components with the same name and label indicate components that are the same or have the same properties and their detailed description is appropriately abbreviated. Further, a single component can serve multiple functions and a plurality of structural elements of the invention can be implemented with the same component. In contrast, the functions of a single component can be divided among a plurality of components. In addition, explanations used to describe part of one embodiment can be used in other embodiments and descriptions.

### First Embodiment

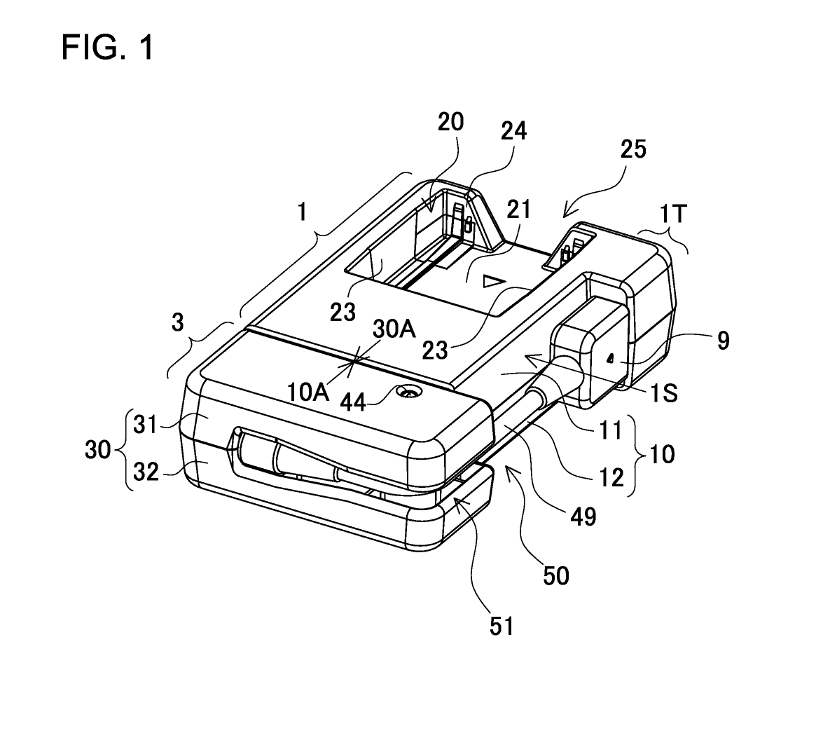

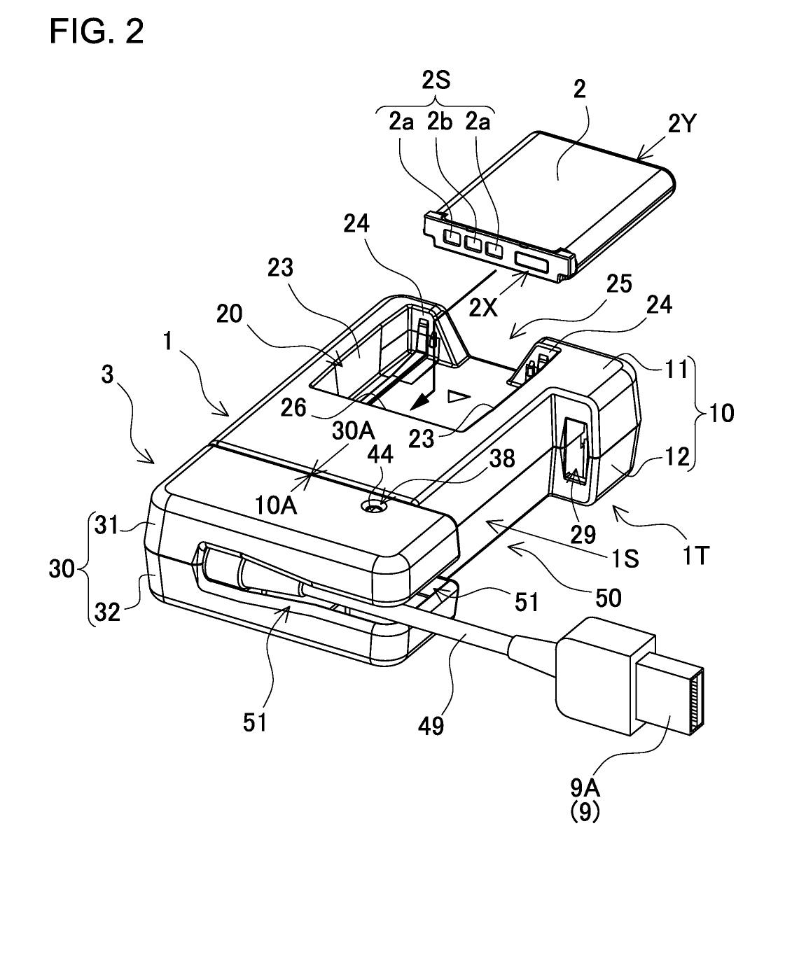

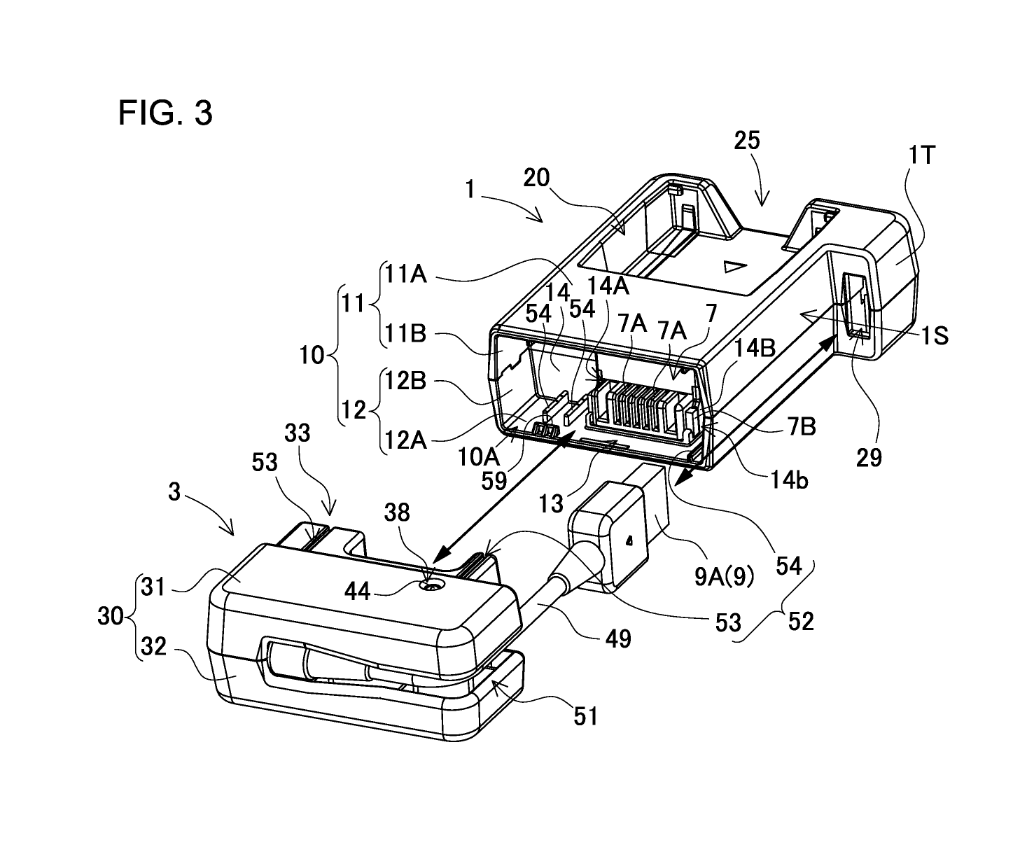

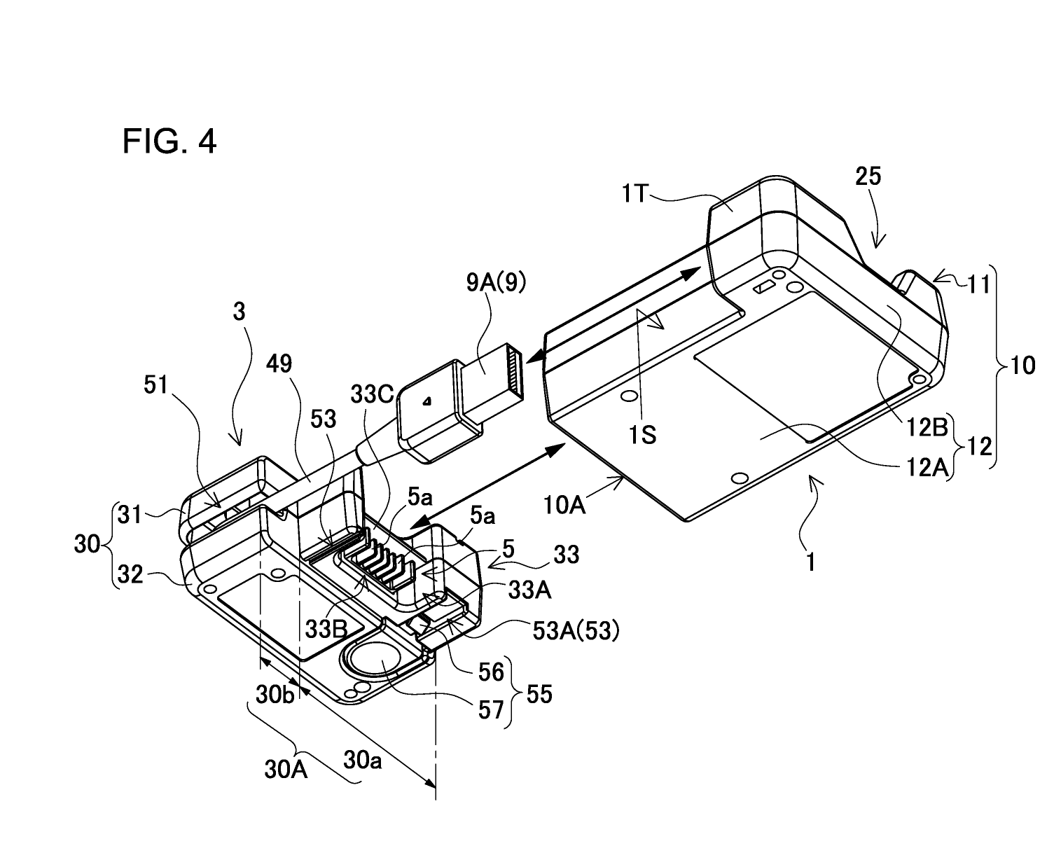

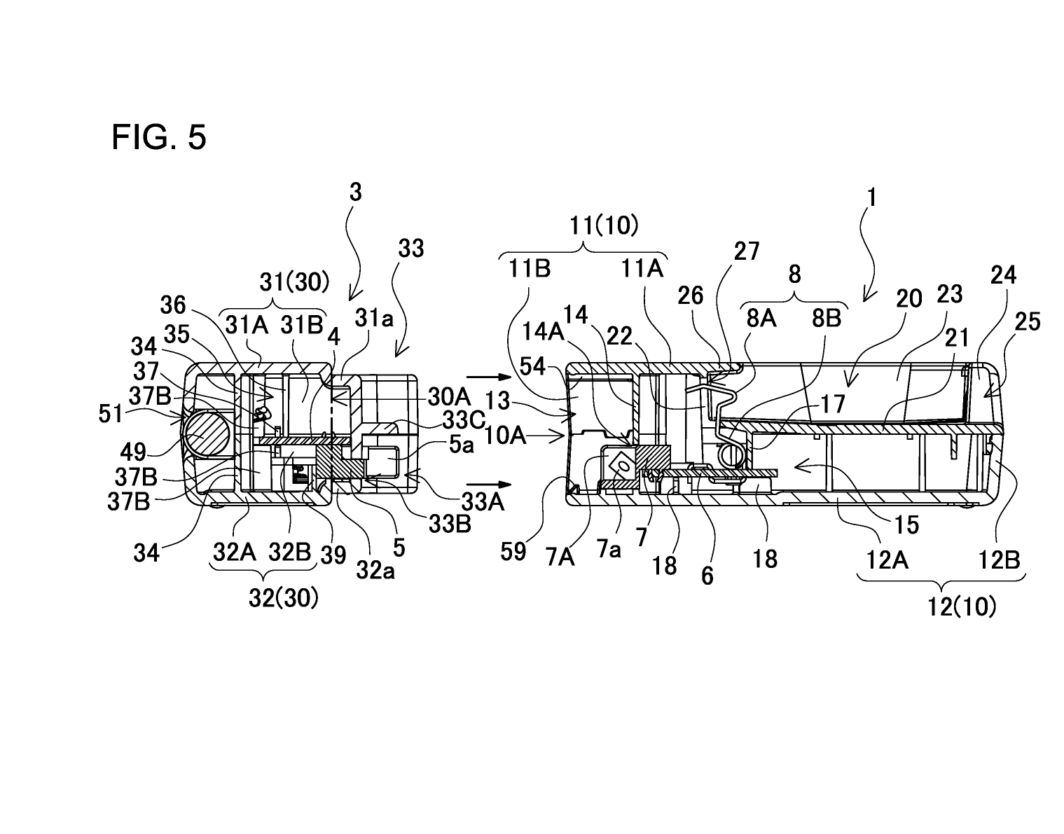

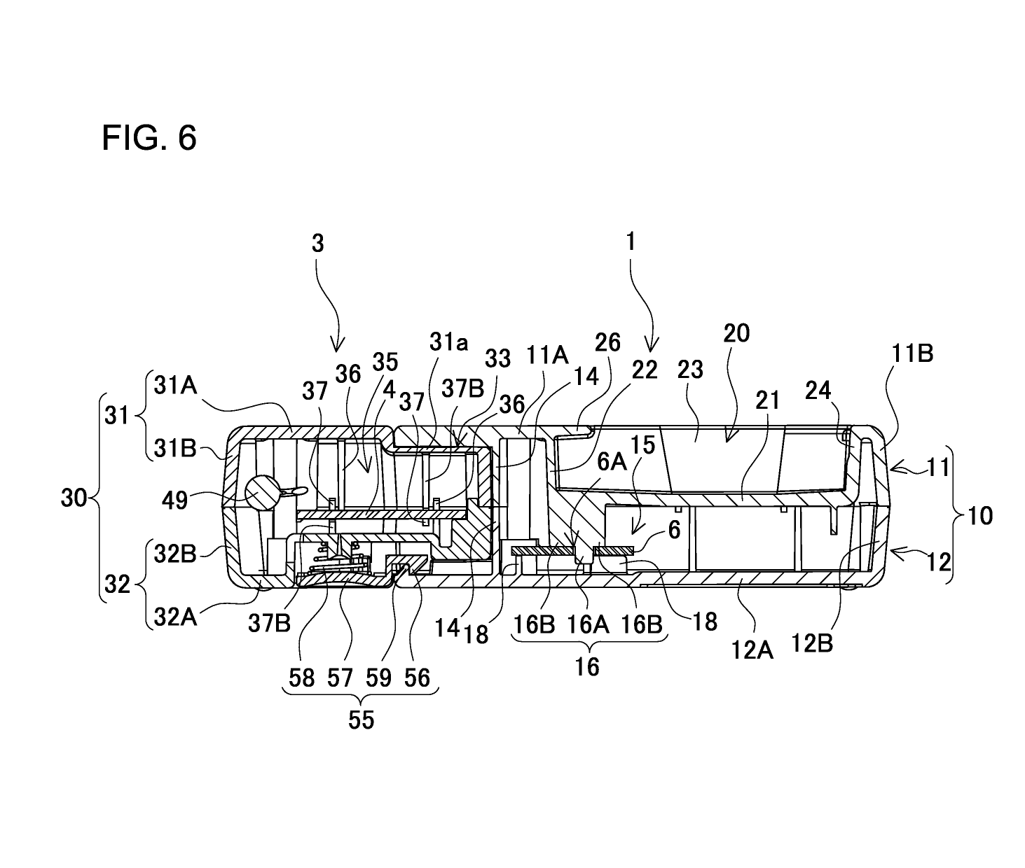

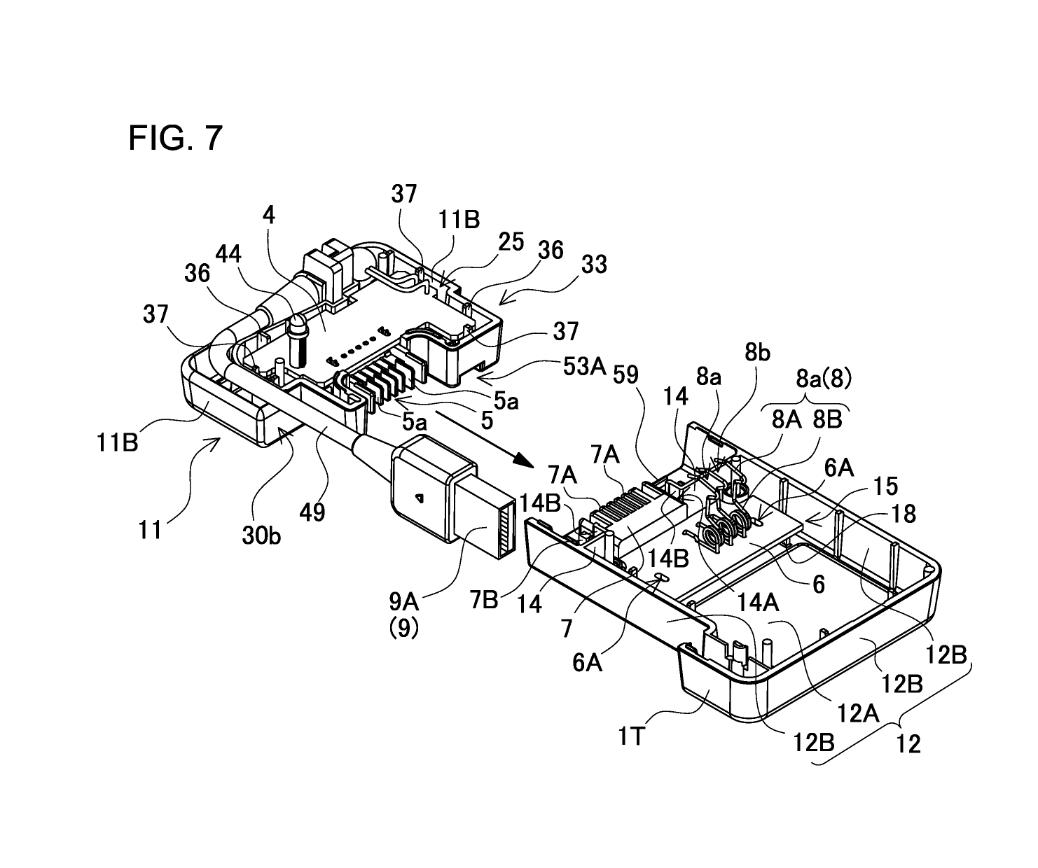

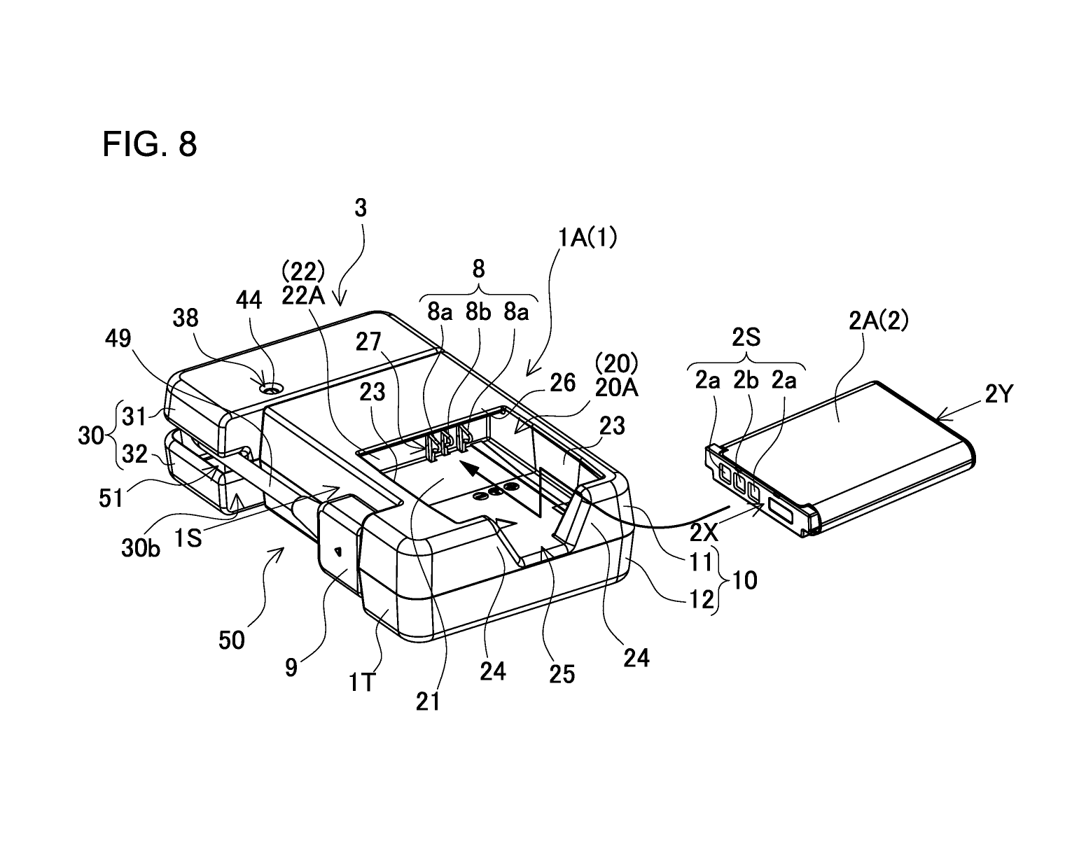

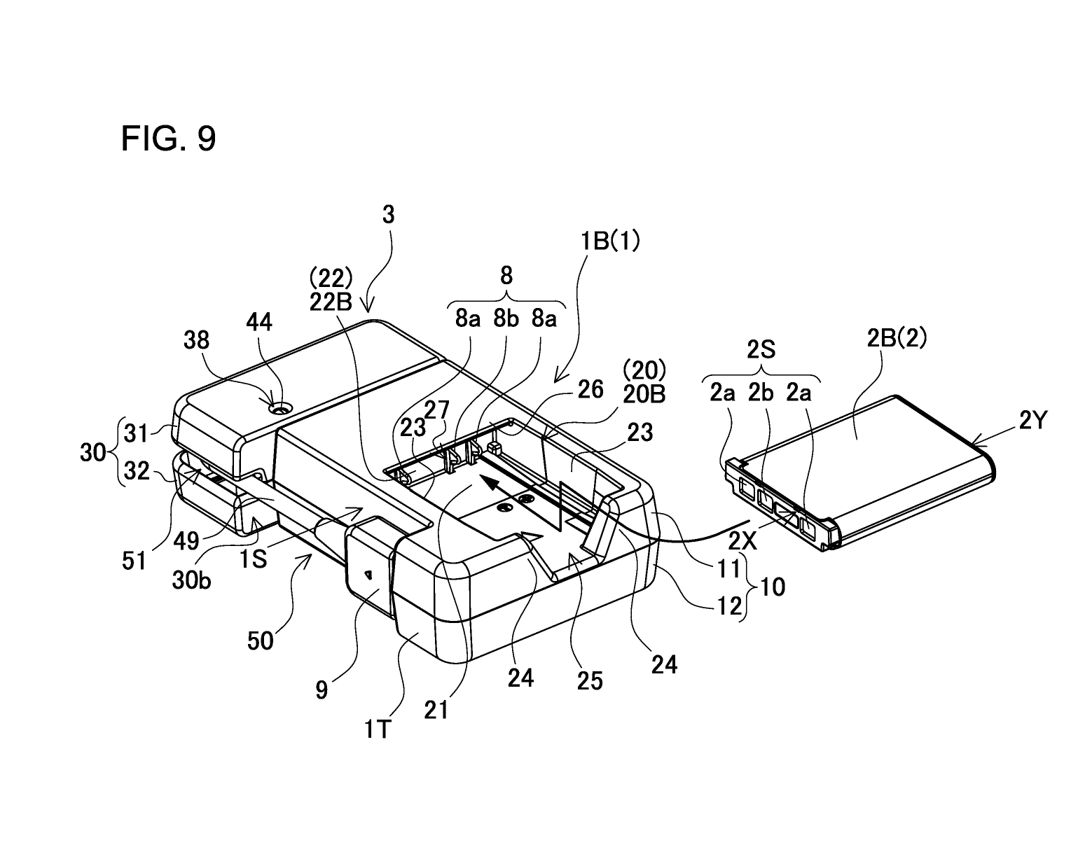

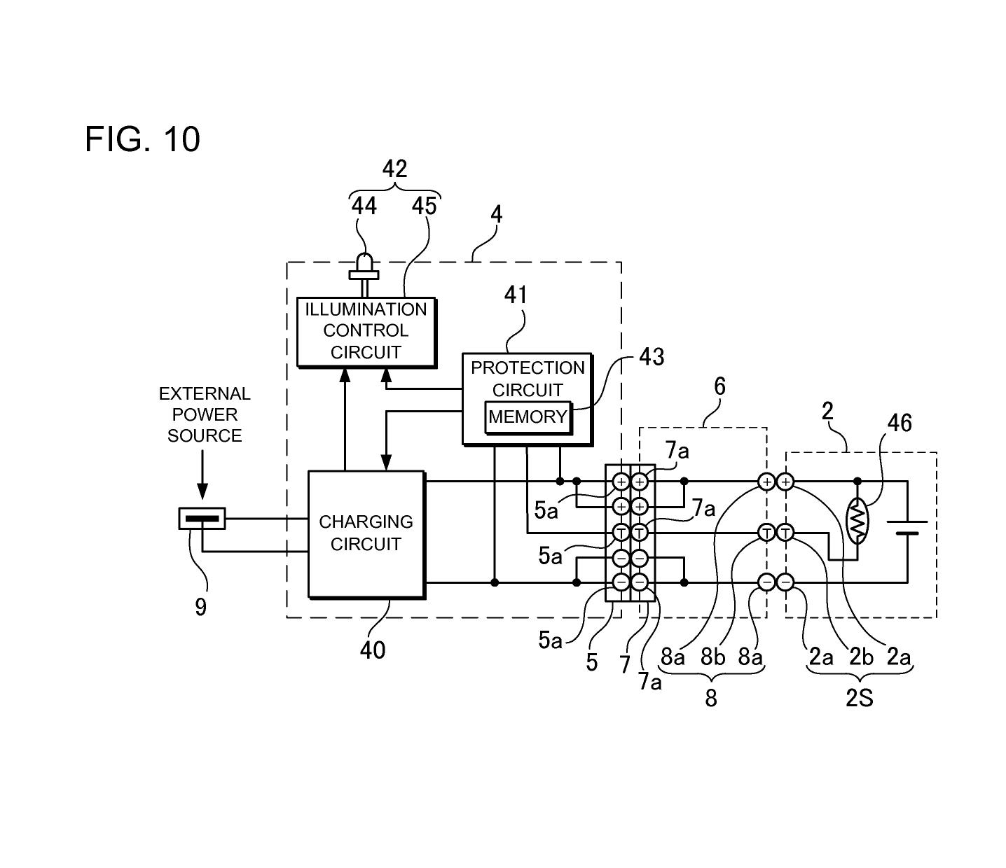

A battery charger for the first embodiment of the present invention is shown in FIGS. 1-10. Accordingly, FIG. 1 is an oblique view from above a battery charger for the first embodiment, FIG. 2 is an oblique view showing the battery charger of FIG. 1 in use, FIG. 3 is an exploded oblique view showing the detachable structure of the charging section and docking section of the battery charger in FIG. 1, FIG. 4 is an oblique view from behind and below the battery charger in FIG. 3, FIG. 5 is an exploded cross-section view of the battery charger in FIG. 1, FIG. 6 is a cross-section view showing the connecting structure of the charging section and docking section of the battery charger in FIG. 1, FIG. 7 is an exploded oblique view showing the internal structure of the battery charger in FIG. 1, FIG. 8 is an oblique view showing attachment of a battery pack in the battery charger of FIG. 1, FIG. 9 is an oblique view showing attachment of a different battery pack in the battery charger of FIG. 1, and FIG. 10 is a block diagram of the battery charger in FIG. 1.

The battery charger shown in these figures is made up of a docking section 1 where a battery pack 2 can be attached for charging, and a charging section 3 that has a charging circuit 40 to supply a prescribed amount of charging power to the battery pack 2 loaded in the docking section 1. As shown in FIGS. 3 and 4, the battery charger is configured with a docking section 1 and charging section 3 that connect in a detachable manner. In this battery charger, a docking section 1 that can accept the battery pack 2 to be charged is connected to the charging section 3, and with the battery pack 2 loaded in that docking section 1, charging power is supplied from the charging section 3 to the docking section 1 to charge the battery pack 2. Further, when a different type of battery pack 2 is charged, the battery charger docking section 1 is exchanged for one that can accept that battery pack 2. With the battery pack 2 loaded in the docking section 1, charging power is supplied from the charging section 3 to charge the battery pack 2. In addition, the present invention includes a battery pack module made up of a battery pack 2 that can be charged, and a docking section 1 where the battery pack 2 can be attached in a detachable manner and a charging section 3 can be connected in a detachable manner to supply a prescribed amount of charging power to the battery pack 2. By exchanging the battery pack module connected to the charging section 3, different types of battery packs 2 can be charged. Further, the present invention includes a battery pack docking module, which is a docking section 1 that can accept a battery pack 2 loaded in a detachable manner and can form a battery charger by connecting a charging section 3 that can charge the battery pack 2. The battery pack 2 can be loaded in the docking section 1, and with the charging section 3 connected, charging power can be received from the charging section 3 to charge the battery pack 2.

### [Docking Section 1]

The docking section 1 accepts battery pack 2 attachment in a detachable manner, and connects with a charging section 3 in a detachable manner to charge the battery pack 2 with charging power supplied from the charging section 3. The docking section 1 is provided with a docking section case 10 that connects with the charging section 3 in a detachable manner. The docking section 1 connects to the charging section 3 with the docking section-side attachment surface 10A of the docking section case 10 facing the charging section-side attachment surface 30A of the charging section 3. To enable attachment and detachment of the docking section 1 with the charging section 3, the docking section case 10 docking section-side attachment surface 10A is provided with a connecting cavity 13 that accepts insertion of a charging section 3 connecting plug 33. In addition, the docking section 1 is provided with a battery loading cavity 20 in the top of the docking section case 10 to accept battery pack 2 attachment.

Further, the docking section 1 in the figures is provided with a docking section-side connector 7 to electrically connect with the charging section 3, and connecting terminals 8 that contact output terminals 2S on a battery pack 2 loaded in the battery loading cavity 20. In the docking section 1 of the figures, the docking section-side connector 7 and the connecting terminals 8 are mounted on a sub-circuit board 6, and the sub-circuit board 6 is housed inside the docking section case 10. The docking section-side connector 7 is disposed inside the connecting cavity 13 and the connecting terminals 8 are disposed in fixed positions in the battery loading cavity 20 by disposing the sub-circuit board in a fixed position inside the docking section case 10. Here, the docking section 1 that makes up the battery pack docking module is provided with a battery loading cavity 20 that can accept attachment of a battery pack for charging, and a docking section-side connector 7 that connects with the charging section 3 in a detachable manner for electrical connection. The battery pack docking module can be configured to attach a battery pack 2 in the battery loading cavity 20, and with the charging section 3 connected via the docking section-side connector 7, charge the battery pack 2 by receiving a prescribed amount of charging power supplied from the charging section 3.

### [Docking Section Case 10]

The docking section case 10 is made of plastic and configured with a separately formed upper case 11 and lower case 12 that have an approximately square shape when viewed from above. The upper case 11 is formed as a top plate 11A with perimeter walls 11B, and the lower case 12 is formed with a bottom plate 12A with perimeter walls 12B. In the docking section case 10 of the figures, opposing perimeter walls 11B, 12B of the upper case 11 and lower case 12 are joined together and the sub-circuit board 6 is disposed inside the compartment 15 formed in the interior.

### [Connecting Cavity 13]

The connecting cavity 13 is established in the docking section-side attachment surface 10A of the docking section case 10 and has an inside shape that can accept insertion of the charging section-side attachment surface 30A connecting plug 33 of the charging section 3. The docking section case 10 has no perimeter walls 11B, 12B in the docking section-side attachment surface 10A making that end of the docking section 1 a hollow cylindrical shape, which is the connecting cavity 13 that accepts charging section 3 connecting plug 33 insertion. As shown in FIGS. 3, 5, and 6, the docking section case 10 is provided with a partition wall 14 facing the end-plane of a connecting plug 33 inserted in the connecting cavity 13 and positioned further inside than the docking section-side attachment surface 10A. This partition wall 14 separates the connecting cavity 13 from the compartment 15 inside the upper case 11 and lower case 12. The partition wall 14 is divided into upper and lower sections that are formed in single-piece construction with the upper case 11 and lower case 12 respectively and are joined together to form the partition wall 14. The space formed inside the upper case 11 and lower case 12 and outside the partition wall 14 of the docking section case 10 is the connecting cavity 13.

### [Battery Loading Cavity 20]

The battery loading cavity 20 is established as an opening in the top of the upper case 11. The docking section case 10 is provided with a cavity in the top of the upper case 11 that is the battery loading cavity 20. The battery loading cavity 20 is made in a shape that can accept attachment in a detachable manner of a battery pack 2 of a particular type that is charged by that docking section 1. Since a rectangular battery attaches in the docking section 1 of the figures, the inside shape of the opening in the battery loading cavity 20 is (approximately) square with perimeter side-walls established on the four sides of a square base-plate 21. The four perimeter side-walls that form the square battery loading cavity 20 are a first side-wall 22 that faces the terminal-end 2X of the battery pack 2, a pair of side-walls 23 that face the two sides of the battery pack 2, and a second side-wall 24 that faces the bottom 2Y of the battery pack 2. These perimeter side-walls are formed approximately perpendicular to the base-plate 21. A battery loading cavity 20 with this configuration can hold a battery pack 2 in a manner that will not fall out.

### [Battery Pack Removal Slot 25]

The docking section case 10 of the figures is provided with a battery pack removal slot 25 in the second side-wall 24 to remove a battery pack 2 attached in the battery loading cavity 20. The battery pack removal slot 25 has a shape that widens towards the upper edges of the battery loading cavity 20. The user can insert a finger tip in the battery pack removal slot 25 to easily eject a loaded battery pack 2.

### [Overhang 26]

As shown in the cross-section of FIG. 5, the upper case 11 is provided with an overhang 26 at the upper edge of the first side-wall 22 that faces the terminal-end 2X of the battery pack 2. In the figures, the edge of the square battery loading cavity 20 opening in the upper case 11 extends into the battery loading cavity 20 to form the overhang 26. As a result of this structure, the first side-wall 22 of the battery loading cavity 20 takes on a recessed shape. A battery loading cavity 20 with a recessed shape can prevent an attached battery pack 2 from inadvertently detaching. In particular, a battery pack 2 with its terminal-end 2X resiliently pressed against the connecting terminals 8 established on the first side-wall 22 is prevented from inadvertently dislodging. In addition, establishing an overhang 26 over the first side-wall 22 limits exposure of the connecting terminals 8 from the first side-wall 22 to effectively prevent contact by operator handling or foreign material while providing protection from dust and dirt ingress.

### [Connecting Terminals 8]

The battery loading cavity 20 has connecting terminals 8 disposed on the first side-wall 22 that contact the output terminals 2S of the battery pack 2. To align the connecting terminals 8 in prescribed locations, the battery loading cavity 20 is provided with positioning slits 27 through which the wire connecting terminals 8 can move in and out. In the battery loading cavity 20 of FIG. 8, the first side-wall 22 is provided with three positioning slits 27 that extend vertically in the figure. The three positioning slits 27 serve to dispose the three connecting terminals 8 in specified locations. The positioning slits 27 in the first side-wall 22 dispose the connecting terminals 8 in locations that contact the output terminals 2S on a battery pack 2 attached in the battery loading cavity 20. The width of the positioning slits 27 is made slightly larger than the diameter of the connecting terminal 8 wire to allow the wire connecting terminals 8 to move freely in and out of the positioning slits 27.

The connecting terminals 8 are made of wire that can deform in a resilient manner. One end of the connecting terminals 8 is fixed to the sub-circuit board 6 by an attachment method such as soldering. Further, each connecting terminal 8 wire is shaped with bends that establish a contact section 8A that makes contact with a battery pack 2 output terminal 2S, and a flexible arm 8B that resiliently presses the contact section 8A against the battery pack 2 output terminal 2S. The wires of the connecting terminals 8 pass through the positioning slits 27 in the first side-wall 22 and the contact sections 8A protrude outward in a flexible manner to press resiliently against the battery pack 2 output terminals 2S. Although one end of the wire connecting terminals 8 is attached to the sub-circuit board 6 in the figures, the connecting terminals can also be configured to make the contact sections flexibly protrude from the positioning slits with one end attached to the docking section case. Connecting terminals attached to the docking section case can connect with the sub-circuit board via lead-wires (not illustrated), or they can directly connect to the docking section-side connector (described later) disposed in the connecting cavity to charge the battery pack.

With a battery pack 2 attached in the battery loading cavity 20 of the docking section 1, connecting terminals 8 protruding from the first side-wall 22 contact battery pack 2 output terminals 2S for charging. Accordingly, connecting terminals 8 are disposed in the docking section 1 in locations corresponding to the output terminals 2S positioned on the terminal-end 2X of the battery pack 2 to be charged. The connecting terminals 8 of the figures are made up of positive and negative charging terminals 8a and a temperature detection terminal 8b. The three connecting terminals 8 are disposed opposite corresponding positive and negative electrode terminals 2a and a temperature terminal 2b that are the output terminals 2S of the attached battery pack 2. Specifically, the positive and negative charging terminals 8a are disposed in positions opposite the positive and negative electrode terminals 2a of the battery pack 2, and the temperature detection terminal 8b is disposed in a position opposite the temperature terminal 2b.

The battery pack 2A in FIG. 8 has three output terminals 2S disposed in a row close to one side of the terminal-end 2X. Accordingly, as shown in the figure, the docking section 1A that accepts that battery pack 2A has three connecting terminals 8 disposed in a row close to one end of the first side-wall 22A and positioned opposite the battery pack 2A output terminals 2S.

In contrast, the battery pack 2B in FIG. 9 has two output terminals 2S disposed close to one side (the left-side in the figure) of the terminal-end 2X, and a single output terminal 2S disposed near the opposite side (the right-side in the figure). Accordingly, as shown in the figure, the battery loading cavity 20B of the docking section 1B that accepts that battery pack 2B has two connecting terminals 8 disposed at one end of the first side-wall 22B opposite two of the battery pack 2B output terminals 2S, and a single connecting terminal 8 disposed at the other end of the first side-wall 22B opposite the single battery pack 2B output terminal 2S.

Although not illustrated, docking sections can be provided to charge various different types of battery packs. Here, each docking section has a battery loading cavity that can accept attachment (in a detachable manner) of a specific type of battery pack, and connecting terminals on the first side-wall of the battery loading cavity are disposed in positions opposite the output terminals of the attached battery pack. Specifically, by manufacturing docking sections with battery loading cavity sizes and shapes and connecting terminal configurations and locations that conform to the shapes and configurations of the targeted battery packs, various types of battery packs can be loaded in a docking section and charged.

### [Sub-Circuit Board 6]

The sub-circuit board 6 holds a plurality of connecting terminals 8 and the docking section-side connector 7 in specified positions. The sub-circuit board 6 is disposed in a fixed position inside the docking section case 10 to expose each connecting terminal 8 from a positioning slit 27 through the first side-wall 22 in the battery loading cavity 20, and dispose the docking section-side connector 7 inside the connecting cavity 13. Specifically, the sub-circuit board 6 disposes the connecting terminals 8 and the docking section-side connector 7 in fixed positions in the docking section case 10. The connecting terminals 8 and docking section-side connector 7 can be mounted on the sub-circuit board 6, and sub-circuit board 6 with the connecting terminals 8 and docking section-side connector 7 attached can be treated as a single assembly unit to be inserted in the docking section case 10. Consequently, this structure has the characteristic that the docking section 1 can be assembled in a simple and efficient manner. However, it is not always necessary to provide a sub-circuit board, and it is also possible to mount the docking section-side connector and connecting terminals directly on the docking section case and make electrical connections through conducting materials such as lead-wires.

The docking section case 10 in FIGS. 5-7 is provided with alignment ribs 16 formed in single-piece construction with the upper case 11 to hold the sub-circuit board 6 in a fixed position in the compartment 15 inside. Accordingly, the sub-circuit board 6 is provided with alignment holes 6A that mate with the alignment ribs 16. Each alignment rib 16 in the figures is configured with an insertion section 16A at the bottom end that inserts into an alignment hole 6A in the sub-circuit board 6, and a pedestal section 16B that steps down in width to the insertion section 16A and that contacts the sub-circuit board 6 to hold it in position. In addition, the upper case 11 shown in FIG. 5 is provided with a reinforcing rib 17 formed in single-piece construction with the base-plate 21 of the battery loading cavity 20 projecting downward to protect attachment regions of the connecting terminals 8 to the sub-circuit board 6. The bottom end of the reinforcing rib 17 makes contact with the top of the sub-circuit board 6 establishing a structure that retains the sub-circuit board 6. Further, the lower case 12 is provided with supporting ribs 18 that make contact with the bottom of the sub-circuit board 6 and support the sub-circuit board 6 holding it in a fixed position. The structure described above can align the sub-circuit board 6 in a prescribed position by inserting alignment rib 16 insertion sections 16A into sub-circuit board 6 alignment holes 6A while retaining the sub-circuit board 6 in a fixed position in the docking section case 10 by sandwiching it from above and below via the alignment rib 16 pedestal sections 16B, the reinforcing rib 17, and the supporting ribs 18. However, although not illustrated, the sub-circuit board can also be disposed in a fixed position inside the docking section case by attachment methods such as pressure fitting, snap-in hooks, or screw attachment.

### [Docking Section-Side Connector 7]

The docking section-side connector 7 is mounted inside the connecting cavity 13 in an exposed manner. The docking section-side connector 7 connects with a charging section-side connector 5 established on the connecting plug 33 that inserts into the connecting cavity 13 to make electrical connection with the charging section 3. A docking section-side connector 7 connected with a charging section-side connector 5 receives battery pack 2 charging power supplied from the charging section 3 charging circuit 40. Charging power received by the docking section-side connector 7 is supplied to connecting terminal 8 charging terminals 8a via the sub-circuit board 6, and is supplied to the battery pack 2 via electrode terminals 2a in contact with the charging terminals 8a to charge the battery pack 2. In addition, the docking section-side connector 7 transmits battery temperature signals from the temperature detection terminal 8b in contact with the battery pack 2 temperature terminal 2b to the charging section 3 via the charging section-side connector 5.

The docking section-side connector 7 shown in the figures is a female connector that mates with the male charging section-side connector 5 on the connecting plug 33 for electrical connection. The female docking section-side connector 7 is provided with contacts 7a disposed between a plurality of insulating plates 7A arranged in parallel orientation. Output terminal blades 5a of the male charging section-side connector 5 insert between adjacent insulating plates 7A of the docking section-side connector 7 to electrically connect the contacts 7a with the output terminal blades 5a. Configuring the docking section-side connector 7 as a female connector can reliably prevent inadvertent detrimental current flow or leakage current through the docking section-side connector 7 from a battery pack 2 attached in the battery loading cavity 20 of the docking section 1. For example, operator electrical shock caused by touching the docking section-side connector exposed inside the connecting cavity 13, and battery pack short circuit caused by a foreign object contacting the docking section-side connector can be reliably prevented with a female connector.

The docking section-side connector 7 shown in FIGS. 5 and 7 is mounted on one side of the sub-circuit board 6. With the sub-circuit board 6 disposed in the compartment 15 of the docking section case 10, the docking section-side connector 7 is disposed inside the connecting cavity 13 in a manner exposed to the outside from a connector window 14A opened in the partition wall 14. In the lower case 12 shown in FIGS. 3 and 7, the partition wall 14 is provided with frame sections 14B that bend outward from the partition wall 14 on both sides of the connector window 14A to hold the docking section-side connector 7 in a fixed position in the connector window 14A. The charging section-side connector 7 is insertion fit into the space between opposing frame sections 14B. In addition, the docking section-side connector 7 shown in the figures is provided with insertion tabs 7B protruding from both sides of the casing for insertion in the lower case 12. The insertion tabs 7B on both sides of the docking section-side connector 7 insert into alignment grooves 14b established in the frame sections 14B of the partition wall 14 to fit the docking section-side connector 7 into a fixed position in the lower case 12.

### [Charging Section 3]

The charging section 3 connects with the docking section 1 in a detachable manner and supplies charging power to the docking section 1 to charge a battery pack 2 loaded in the docking section 1. The charging section 3 is provided with a box-shaped main case 30. The charging section 3 connects with the docking section 1 with the charging section-side attachment surface 30A of the main case 30 facing the docking section-side attachment surface 10A of the docking section 1. To connect with the docking section 1 in a detachable manner, the charging section 3 is provided with a connecting plug 33 in the charging section-side attachment surface 30A of the main case 30 that fits into the connecting cavity 13 in the docking section 1.

The charging section 3 is provided with a charging circuit 40 that supplies a prescribed amount of charging power to charge the battery pack 2 loaded in the docking section 1, a connector 9 to receive charging power from the outside to charge the battery pack 2, and a charging section-side connector 5 to electrically connect with the docking section 1. The charging section 3 shown in FIGS. 5-7 and 10 is provided with a circuit board 4 that carries electronic components implementing the charging circuit 40, and that circuit board 4 is housed inside the main case 30. The circuit board 4 is connected to the connector 9 via a cable 49, and the charging section-side connector 5 is mounted on one side of the circuit board 4 to dispose it in a fixed position in the connecting plug 33.

### [Main Case 30]

The main case 30 is plastic and made up of a first case 31 and a second case 32. The first case 31 is a first surface plate 31A with surrounding perimeter walls 31B formed in single-piece construction, and the second case 32 is a second surface plate 32A with surrounding perimeter walls 32B formed in single-piece construction. The main case 30 of the figures forms an overall box-shape by joining together opposing perimeter walls 31B, 32B of the first case 31 and the second case 32.

### [Connecting Plug 33]

The connecting plug 33 protrudes from the charging section-side attachment surface 30A of the main case 30 and is shaped to fit in the connecting cavity 13 in the docking section-side attachment surface 10A of the docking section 1. The main case 30 in FIGS. 3-9 is made by joining the first case 31 and the second case 32, and the connecting plug 33 is formed in single-piece construction protruding from the charging section-side attachment surface 30A. The connecting plug 33 is formed in a shape protruding from the charging section-side attachment surface 30A by joining perimeter walls 31B, 32B around a protruding section 31a on the first surface plate 31A and a protruding section 32a on the second surface plate 32A.

In the charging section 3 of FIG. 4, the main case 30 charging section-side attachment surface 30A is divided into an attachment region 30a provided with the connecting plug 33 and a non-attachment region 30b where the connecting plug 33 is not established. The attachment region 30a is provided opposite the docking section-side attachment surface 10A of the docking section 1. The non-attachment region 30b of the main case 30 in FIG. 4 is disposed at one end, in the lengthwise direction, of the rectangular charging section-side attachment surface 30A. In the battery charger of the figures, the long side of the charging section-side attachment surface 30A of the charging section 3 is made longer than the long side of the docking section-side attachment surface 10A of the docking section 1, and the short sides of the charging section-side attachment surface 30A and the docking section-side attachment surface 10A are made approximately equal. As shown in FIG. 1, with the charging section 3 and docking section 1 connected together, this battery charger is designed to have coplanar exterior surfaces along the charging section 3 and docking section 1. Specifically, upper surfaces, lower surfaces, and surfaces along one side of the connected charging section 3 and docking section 1 are made to be in the same plane. Accordingly, the connecting plug 33 of the charging section 3 is made with a shape smaller around the perimeter than the outside of the docking section-side attachment surface 10A to allow it to fit inside the connecting cavity 13 of the docking section 1.

### [Storage Area 35]

The circuit board 4 is housed in a storage area 35 formed inside the main case 30. The main case 30 of the figures is provided with a partition 34 connected to the inside surfaces of the first case 31 and second case 32, and the circuit board 4 storage area 35 is established between that partition 34 and the inside surfaces of the perimeter walls 31B, 32B. The partition 34 is vertically divided into sections formed in single-piece construction with first case 31 and the second case 32 and subsequently joined together. In the main case 30 in FIG. 7, the partition 34 is established along the side of the charging section 3 opposite from the charging section-side attachment surface 30A and along a boundary of the non-attachment region 30b. Specifically, the circuit board 4 storage area 35 is provided in the main case 30 inside perimeter walls 31B, 32B of the charging section 3 and connecting plug 33, inside perimeter walls 31B, 32B along the attachment region 30a of the charging section-side attachment surface 30A, and inside the partition 34.

To dispose the circuit board 4 in a fixed position, the main case 30 of the figures is provided with a plurality of alignment ribs 36, 37 on the inside surfaces of the perimeter walls 31B, 32B and partition 34 that establish the storage area 35. The alignment ribs 36, 37 of the figures are established in crossing configuration around the outside edges of the circuit board 4. The alignment ribs 36, 37 are disposed with their inside surfaces facing the outside edges of the circuit board 4 to align the circuit board 4 in a fixed position inside the storage area 35. Further, the alignment ribs 37 are formed in stepped shapes, and the wider step regions 37B act as supports that contact the circuit board 4 and support its upper and lower surfaces. This structure aligns the perimeter of the circuit board 4 via the alignment ribs 36, 37, and sandwiches the circuit board 4 from above and below with the step regions 37B of the alignment ribs 37 to retain it in a fixed position inside the main case 30. However, although not illustrated, the circuit board can also be disposed in a fixed position in the main case by attachment methods such as pressure fitting, snap-in hooks, or screw attachment.

### [Circuit Board 4]

As shown in the block diagram of FIG. 10, the charging section 3 is provided with a charging circuit 40 that charges a battery pack 2 with power supplied from an external power source, a protection circuit 41 that controls battery pack 2 charging according to battery temperature and voltage input from the battery pack 2, and a display section 42 that displays charging status and errors to the outside. Consequently, the circuit board 4 carries electronic components that implement those circuits.

The charging circuit 40 converts power supplied from the connector 9, which is connected to an external power source, to charging power to charge the battery pack 2. In a battery charger for charging a battery pack 2 with lithium ion batteries, the charging circuit 40 charges the battery pack 2 with constant current and constant voltage. In a battery charger for charging a battery pack with nickel hydride batteries or nickel cadmium batteries, the charging circuit performs constant current charging to charge the battery pack. In addition, the charging circuit 40 detects full-charge of the battery pack 2 to terminate charging.

The protection circuit 41 detects battery temperature and voltage and controls charging while protecting the battery pack 2. Battery temperature is detected by a temperature sensor 46 housed in the battery pack 2 and is determined from a signal output from the temperature terminal 2b on terminal-end 2X of the battery pack 2. The protection circuit 41 is provided with memory 43 to store temperatures that limit battery pack charging current. The memory 43 stores allowable current corresponding to battery temperature. The allowable current is the maximum current that can be passed through the battery pack 2 at a given temperature, and a current lower than that is used. Accordingly, the protection circuit 41 protects the battery pack 2 by controlling battery pack 2 charging current lower than the allowable current corresponding to the battery temperature. In addition, the protection circuit can store the maximum and minimum temperatures that allow battery pack charging, and control can allow charging within those maximum and minimum temperatures. Optimum maximum temperature and minimum temperature are set according to the battery type. For example, for a lithium ion battery, the maximum temperature is approximately 60° C. to 70° C., and the minimum temperature is approximately −10° C. to 0° C.

The protection circuit 41 also detects battery pack 2 voltage to control charging. The protection circuit 41 terminates charging when the voltage of the battery pack 2 being charged reaches a maximum voltage. The protection circuit 41 shown in FIG. 10 controls the charging circuit 40 to terminate battery pack 2 charging when an abnormal temperature or voltage is detected.

The display section 42 receives battery pack 2 charging status and error signals from the charging circuit 40 and protection circuit 41 and displays that information to the outside. The display section 42 of the figures is provided with a light source that is a light emitting diode (LED) 44, and an illumination control circuit 45 that controls illumination of the LED 44. The display section 42 detects battery pack 2 charging by the charging circuit 40 and termination of charging when the battery pack 2 reaches full-charge to control illumination of the LED 44 via the illumination control circuit 45. When battery pack 2 charging begins, the illumination control circuit 45 lights the LED 44 to indicate charging in progress. When the battery pack 2 is fully-charged, the illumination control circuit 45 turns the LED 44 OFF to indicate completion of charging. Further, when battery pack 2 voltage or battery temperature rises abnormally, the LED 44 is blinked ON and OFF to indicate a battery pack 2 abnormality. This display section 42 can display information such as battery pack 2 charging status and abnormalities (errors) by controlling the state of illumination of a monochromatic LED 44.

However, the display section can also indicate battery pack charging status and errors by changing LED illumination color. For example, the display section can illuminate an orange LED during battery pack charging, and can change the periodicity of blinking illumination to indicate the amount of remaining battery pack capacity. In this type of display section, the LED blinking frequency can increase as the battery pack approaches full-charge to indicate the state of charge to the user. Further, when the battery pack becomes fully-charged, that can be indicated by green LED illumination. In addition, battery abnormalities can be indicated by blinking illumination of another color or multiple colors, or abnormalities can be indicated by a special pattern of blinking.

The circuit board 4 shown in FIG. 7 has an LED 44 mounted on its upper surface. The first case 31 of the main case 30 is provided with an opening 38 that exposes the LED 44 to make LED 44 indications visible from the outside. However, LED light can also be transmitted through the main case to make indications visible from the outside without establishing an opening to expose the LED. This type of case is made from translucent plastic. In particular, this type of case can be made thin at the location corresponding to the LED to establish a light transmitting region that allows light emitted from the LED to be efficiently transmitted through the case and shined outside.

### [Charging Section-Side Connector 5]

The charging section 3 has the charging section-side connector 5 connected to the output-side of the charging circuit 40. The charging section-side connector 5 shown in FIGS. 5 and 7 is mounted at one side of the circuit board 4, and with the circuit board 4 disposed in the storage area 35 of the main case 30, the charging section-side connector 5 is disposed in an exposed manner in the lower region of the connecting plug 33 in a recessed section 33A. With the connecting plug 33 inserted in the docking section 1 connecting cavity 13, the charging section-side connector 5 connects with the docking section-side connector 7 disposed in the connecting cavity 13 to make electrical connection with the docking section 1. The charging section-side connector 5 connected with the docking section-side connector 7 supplies charging power output from the charging circuit 40 to the docking section 1. In addition, the charging section 3 receives signals from the battery pack 2 temperature terminal 2b via the charging section-side connector 5.

The charging section-side connector 5 shown in the figures is disposed on the inside of the recessed section 33A and exposed to the outside through a connector window 33B opened through a wall of the recessed section 33A. To hold the charging section-side connector 5 in a fixed position inside the recessed section 33A, the connector window 33B is opened through a perimeter wall 32B of the second case 32, and a supporting projection 39 is formed in single-piece construction with the second case 32 to hold the backside of the charging section-side connector 5, which is in the storage area 35. The charging section-side connector 5 has its sides aligned in the connector window 33B by the edges of that opening, and has its backside held by the supporting projection 39 to dispose it in a fixed position in the second case 2.

The charging section-side connector 5 shown in the figures is a male connector that mates with the female docking section-side connector 7 to make electrical connection. The male charging section-side connector 5 is provided with a parallel arrangement of a plurality of output terminal blades 5a. To protect the externally exposed charging section-side connector 5, the connecting plug 33 shown in the figures is provided with a cover plate 33C formed in single-piece construction with the first case 31 that covers the top of the charging section-side connector 5. The cover plate 33C is established along the top of the output terminal blades 5a that make up the charging section-side connector 5. The charging section-side connector 5 is disposed in the lower recessed section 33A and is covered from above by the cover plate 33C to effectively prevent conditions such as short circuit due to insertion of a foreign object from above.

### [Connector 9]

The input-side of the charging circuit 40 in the charging section 3 is connected to a connector 9 via a cable 49. The connector 9 is a standardized connector that makes it easy to supply power without having to provide an external power source such as an AC adapter (as required by prior art). The connector 9 shown in the figures is a USB connector 9A. A connector 9 that is a USB connector 9A uses a USB port (such as a USB charging port) as an external power source. With the connector 9 connected to an external power source, power supplied from that external power source is delivered to the circuit board 4 charging circuit 40 via the cable 49. However, the connector 9 does not necessarily have to be a USB connector, and any configuration that can supply power from a power source can be used. For example, power can also be supplied to the charging section from an externally connected AC adapter. In addition, the charging section can be provided with plug blades that connect with a commercial power outlet, and AC power supplied from the plug blades can be converted to direct current (DC) to charge the battery pack. In that case, the charging section is provided with a rectifying circuit that converts the input AC to DC, the rectified DC power is converted to charging power by the charging circuit, and that power is output to charge the battery pack.

### [Cable 49]

The cable 49 is flexible and one end is inserted into the main case 30 to connect with the circuit board 4. The outer end of the cable 49 has the connector 9 attached to extend it outside away from the main case 30. The cable 49, which extends out from the main case 30, is aligned in a perimeter groove 51 established in the perimeter walls 31B, 32B of the main case 30. In the main case 30 of the figures, the perimeter groove 51 is established in the main case 30 surface at the opposite end from the docking section 1 and along the non-attachment region 30b side. The perimeter groove 51 is configured as a channel with a cross-section that can hold the cable 49. This structure forms the perimeter groove 51 along the outside of the main case 30 to store the cable 49 in a compact manner that does not increase the outline of the main case 30.

In addition, the docking section case 10 of the figures is provided with a case extension 1T at the opposite end of the docking section case 10 from the docking section-side attachment surface 10A, and that case extension 1T lines up with the non-attachment region 30b of the charging section-side attachment surface 30 of the charging section 3. A connector storing cavity 29 is provided in the case extension 1T to accept insertion of the front end of the connector 9. The connector storing cavity 29 is established on the surface of the case extension 1T that faces the opposing surface of the charging section 3, which is the non-attachment region 30b. As shown in FIG. 1, when a battery pack 2 is not being charged, this structure allows the end of the connector 9 to be protected by insertion in the connector storing cavity 29. The cable 49 has a length that allows it to be stored in the perimeter groove 51 without jutting out when the connector 9 is inserted in the connector storing cavity 29.

Further, since the charging section 3 non-attachment region 30b and the case extension 1T at the other end of the docking section 1 protrude out from a side 1S of the docking section 1, a recessed region 50 is formed along the side 1S of the battery charger. As shown in FIG. 1, when a battery pack 2 is not being charged, the cable 49 is stored in the perimeter groove 51 of the main case 30 while the end of the connector 9 is inserted in the connector storing cavity 29 in the docking section case 10. This arrangement allows the connector 9 to be compactly stored in the recessed region 50 formed along the side 1S of the battery charger. In particular, the cable 49 and connector 9 can be protected while improving overall aesthetics by keeping the flexible cable 49 and connector 9 from sticking out from the side of the battery charger.

### [Insertion Guides 52]

The battery charger is also provided with insertion guides 52 on the charging section 3 connecting plug 33 and in the docking section 1 connecting cavity 13 to insure that the connecting plug 33 inserts into the connecting cavity 13 in the proper disposition. For the connecting plug 33 and connecting cavity 13 shown in the figures, a plurality of insertion guides 52 is established extending in the connecting plug 33 insertion direction. The insertion guides 52 shown in FIGS. 3 and 4 are made up of grooves 53 established in the surfaces of the connecting plug 33 and guide rails 54 provided inside the docking section 1 connecting cavity 13. Grooves 53 are established on both sides of the upper and lower surfaces of the connecting plug 33 in the figures. Likewise, guide rails 54 are established on both sides of the upper and lower surfaces inside the docking section 1 connecting cavity 13. Connecting plug 33 grooves 53 are established in locations corresponding to connecting cavity 13 guide rails 54 to allow connecting plug 33 insertion into the connecting cavity 13 with the guide rails 54 inserted in the grooves 53. This configuration, which inserts the connecting plug 33 into the connecting cavity 13 via insertion guides 52, insures that the docking section-side connector 7 and charging section-side connector 5 engage and make contact in the proper direction to minimize contact resistance problems. The grooves 53 and guide rails 54 are established asymmetrically with respect to the left and right sides of the connecting plug 33 to prevent backward insertion of the connecting plug 33 in the connecting cavity 13.

### [Locking Mechanism 55]

In addition, the connecting plug 33 shown in FIGS. 4 and 6, has the groove 53 on one side of its lower surface formed wider than the rest, and that wide groove 53A additionally serves to implement a locking mechanism 55 that holds the connecting plug 33 in the connecting cavity 13. The locking mechanism 55 latches the connecting plug 33 into the connecting cavity 13 and prevents it from inadvertently coming out. The locking mechanism 55 shown in the figures is disposed inside the wide groove 53A. The locking mechanism 55 is made up of a locking hook 56 disposed in a manner free to retract and extend from the surface (lower surface in the figures) of the connecting plug 33, a release actuator 57 that retracts the locking hook 56 attached at one end of the release actuator 57 to the inside of the connecting plug 33 when pressed by the operator, resilient material 58 that presses resiliently against the release actuator 57 in a direction that extends the locking hook 56 and causes it to protrude out into the wide groove 53A, and a locking projection 59 disposed on the inside of the connecting cavity 13 that is guided into the wide groove 53A to become latched with the locking hook 56.

When the connecting plug 33 is inserted in the connecting cavity 13, the locking projection 59 of the locking mechanism 55 is inserted in the wide groove 53A. Inside the wide groove 53A, the locking hook 56 and locking projection 59 slide together along their opposing inclined surfaces and latch together when the connecting plug 33 is completely inserted in the connecting cavity 13. In this state, the connecting plug 33 is connected with the connecting cavity 13 in a manner that does not come apart. To separate the connecting plug 33 and connecting cavity 13, the release actuator 57 is pressed to release the locking hook 56 from the latched condition with the locking projection 59, and the docking section 1 and charging section 3 are separated to extract the connecting plug 33 from the connecting cavity 13. It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims. The present application is based on Application No. 2011-239,785 filed in Japan on Oct. 31, 2011, the content of which is incorporated herein by reference.

What is claimed is:

1. A battery charger for charging a battery pack, the battery charger comprising:
a docking section where the battery pack can be attached for charging; and
a charging section having a charging circuit to supply a given amount of charging power to the battery pack attached in the docking section,
wherein the docking section and charging section having a detachable structure.

2. The battery charger as cited in claim 1 wherein the charging section has a connector to receive external charging power to charge the battery pack, and that connector is a standardized connector that meets certain specifications.

3. The battery charger as cited in claim 2 wherein the connector is a USB connector.

4. The battery charger as cited in claim 3 wherein the USB connector extends out from the charging section through a flexible cable and the docking section is provided with a connector storing cavity to hold the USB connector.

5. The battery charger as cited in claim 4,
wherein the charging section has a box-shaped exterior and one rectangular surface of the box-shaped charging section is a charging section-side attachment surface for attachment with the docking section,
wherein the docking section has a docking section-side attachment surface for attachment with the charging section that has a long side, which is shorter than the length of the charging section-side attachment surface, and a short side, which is approximately equal to the short side of the charging section-side attachment surface; the end-plane at the opposite end of the docking section from the docking section-side attachment surface is approximately the same size as the charging section-side attachment surface, and
wherein when the charging section and the docking section are connected, a recessed region is formed along a side of the battery charger, which is configured to dispose the USB connector in that recessed region.

6. The battery charger as cited in claim 2,
wherein the charging section is provided with a charging section-side connector for electrical connection with the docking section, and the docking section is provided with a docking section-side connector for electrical connection with the charging section,
wherein the docking section-side connector is a female connector, the charging section-side connector is a male connector, and the docking section-side connector and charging section-side connector are configured to fit together.

7. The battery charger as cited in claim 1,
wherein the docking section is provided with a battery loading cavity to attach a battery pack in a given orientation; the battery loading cavity is provided with perimeter side-walls that surround a battery pack attached in the battery loading cavity,
wherein the perimeter side-walls include a first side-wall that faces the terminal-end of the battery pack where output terminals are established, and a second side-wall at the opposite end of the battery loading cavity from the first side-wall that faces the bottom of the battery pack, which is at the opposite end of the battery pack from the terminal-end,
wherein the first side-wall is provided with an overhang that protrudes out to cover the terminal-end of a battery pack attached in the battery loading cavity, and the second side-wall is provided with a battery pack removal slot that exposes the bottom end of a battery pack attached in the battery loading cavity.

8. A battery pack docking module capable of forming a battery charger by connecting with a charging section for charging a battery pack, the battery pack docking module comprising:
a battery loading cavity where a battery pack can be loaded for charging; and
a docking section-side connector that connects in a detachable manner with the charging section for electrical connection,
wherein the battery pack docking module is configured to attach a battery pack in the battery loading cavity, and with the charging section connected via the docking section-side connector, receive a prescribed amount of charging power supplied from the charging section to charge the battery pack.

9. A battery pack module comprising:
a battery pack that can be charged; and
a docking section that connects in a detachable manner with a charging section, which supplies a prescribed amount of charging power to the battery pack,
wherein the battery pack is attached in the docking section, and the docking section is connected with the charging section to charge the battery pack.
